(19) United States
(12) Patent Application Publication
(10) Pub. No.: US 2026/0178957 A1
(43) Pub. Date: Jun. 25, 2026

(54) SYSTEMS AND METHODS FOR PARAMETER SETTING IN QUANTUM APPROXIMATE OPTIMIZATION ALGORITHM AT HIGH DEPTH

(71) Applicant: JPMORGAN CHASE BANK, N.A., New York, NY (US)

(72) Inventors: Dylan HERMAN, Woodcliff Lake, NJ (US); Shreehari SURESHBABU, Norwalk, CT (US); Ruslan SHAYDULIN, New York, NY (US); Zichang HE, Jersey City, NJ (US); Rudy Raymond Harry PUTRA, Manhattan, NY (US); Changhao LI, New York, NY (US); Marco PISTOIA, New York, NY (US); Anuj APTE, Chicago, IL (US)

(21) Appl. No.: 19/000,044

(22) Filed: Dec. 23, 2024

(51) Int. Cl. G06N 10/60; G06N 10/20

(52) U.S. Cl. CPC G06N 10/60; G06N 10/20

(57) ABSTRACT

A method may include: a classical computer program receiving a combinatorial optimization problem; initializing QAOA parameters for a quantum circuit; setting an initial depth and a maximum depth for the quantum circuit, a choice of basis, and a number of basis coefficients; determining that a current depth of the quantum circuit is less than or equal to the maximum depth; transforming the QAOA parameters to the basis coefficients; determining that a relative performance improvement for the basis coefficients is less than a threshold; transforming the basis coefficients to the QAOA parameters; simulating execution of a quantum circuit with the QAOA parameters, resulting in a bitstring; updating the basis coefficients based on the bitstring; determining that a current depth of the quantum circuit is greater than the maximum depth; executing the quantum circuit with the optimized QAOA; and outputting a final bitstring as a solution to the combinatorial optimization problem.

### BACKGROUND OF THE INVENTION

### 1. Field of the Invention

Embodiments relate to systems and methods for parameter setting in quantum approximate optimization algorithm at high depth.

### 2. Description of the Related Art

The Quantum Approximate Optimization Algorithm, or “QAOA,” is a promising heuristic for solving challenging combinatorial optimization problems, such as constraint satisfaction problems. Examples of combinatorial optimization problems include the travelling salesman problem, portfolio optimization, etc. QAOA works by applying a series of alternating, parameterized quantum evolutions called “layers” to drive an initial, easy-to-prepare, quantum state to a quantum state that encodes the solution(s) to the combinatorial problem. The number of layers is denoted by p. Each layer has two operators, called the phase operator and the mixing operator and corresponding to each operator is a free parameter, denoted by gamma (corresponding to the phase operator) and beta (corresponding to the mixing operator). A sufficiently high number of layers, p, is required to achieve a high-quality solution.

Known approaches for applying QAOA generally include: (1) preparing the quantum circuit encoding optimization problem in QAOA; (2) optimizing QAOA parameters to maximize some chosen metric of algorithm success, such as expected solution quality; and (3) executing the QAOA circuit with optimized QAOA parameters and read off the solutions from measurement outcomes. Step 2 requires tuning the two free QAOA parameters for each layer (2p), which can be extremely challenging or even infeasible for a sufficiently large number of layers, such as p=1000. In addition, direct optimization of QAOA parameters can require an infeasible amount of communication between the classical computer and the quantum computer.

### SUMMARY OF THE INVENTION

Systems and methods for parameter setting in quantum approximate optimization algorithm at high depth are disclosed. For example, Quantum Approximate Optimization Algorithm (“QAOA”) parameters may be optimized in the frequency space, which due to smoothness consideration, results in the optimization of significantly fewer parameters.

Embodiments may further use a fitting procedure that is done to “warm start” the parameter optimization process, so that fewer parameters can be optimized to obtain better performance that current solutions.

According to an embodiment, a method may include: receiving, by a classical computer program executed by a classical electronic device, a combinatorial optimization problem; initializing, by the classical computer program, QAOA parameters for a quantum circuit for the combinatorial optimization problem; setting, by the classical computer program, an initial depth for the quantum circuit, a maximum depth for the quantum circuit, a choice of basis, and a number of basis coefficients; determining, by the classical computer program, that a current depth of the quantum circuit is less than or equal to the maximum depth; transforming, by the classical computer program, the QAOA parameters to the basis coefficients, wherein a number of basis coefficients is less than a number of QAOA parameter; determining, by the classical computer program, that a relative performance improvement for the basis coefficients is less than a threshold; transforming, by the classical computer program, the basis coefficients to the QAOA parameters; simulating, by the classical computer program, execution of a quantum circuit with the QAOA parameters, resulting in a bitstring; updating, by the classical computer program, the basis coefficients based on the bitstring; determining, by the classical computer program, that a current depth of the quantum circuit is greater than the maximum depth; executing, by the classical computer, the quantum circuit with the optimized QAOA parameters based on the updated basis coefficients on a quantum computer, resulting in a final bitstring; and outputting, by the classical computer, the final bitstring as a solution to the combinatorial optimization problem.

In one embodiment, the basis may include a plurality of polynomials where any function on [0,1] interval can be represented as a linear combination of these polynomials.

In one embodiment, the basis may include a Chebyshev basis polynomial.

In one embodiment, the method may also include: setting, by the classical computer program, a depth increment; increasing, by the classical computer program, a number of coefficients by the depth increment in response the relative performance improvement being less than the threshold; and interpolating, by the classical computer program, a curve of the QAOA parameters as a function of the depth and the depth plus the depth increment.

In one embodiment, the method may also include: determining, by the classical computer program, that a relative performance improvement for the basis coefficients is greater than the threshold; and interpolating, by the classical computer program, a curve of the QAOA parameters as a function of the depth and the depth plus the depth increment.

In one embodiment, the classical computer program may also set a desired threshold for an approximation ratio.

According to another embodiment, a system may include: a classical electronic device executing a classical computer program; and a quantum computer in communication with the classical computer. The classical computer program receives a combinatorial optimization problem; the classical computer program initializes QAOA parameters for a quantum circuit for the combinatorial optimization problem; the classical computer program sets an initial depth for the quantum circuit, a maximum depth for the quantum circuit, a choice of basis, and a number of basis coefficients; the classical computer program determines that a current depth of the quantum circuit is less than or equal to the maximum depth; the classical computer program transforms the QAOA parameters to the basis coefficients, wherein a number of basis coefficients is less than a number of QAOA parameter; the classical computer program determines that a relative performance improvement for the basis coefficients is less than a threshold; the classical computer program transforms the basis coefficients to the QAOA parameters; the classical computer program simulates execution of a quantum circuit with the QAOA parameters, resulting in a bitstring; the classical computer program updates the basis coefficients based on the bitstring; the classical computer program determines that a current depth of the quantum circuit is greater than the maximum depth; the quantum computer executes the quantum circuit with the optimized QAOA parameters based on the updated basis coefficients, resulting in a final bitstring; and the classical computer outputs the final bitstring as a solution to the combinatorial optimization problem.

In one embodiment, the basis may include a plurality of polynomials where any function on [0,1] interval can be represented as a linear combination of these polynomials.

In one embodiment, the basis may include a Chebyshev basis polynomial.

In one embodiment, the classical computer program sets a depth increment; the classical computer program increases a number of coefficients by the depth increment in response the relative performance improvement being less than the threshold; and the classical computer program interpolates a curve of the QAOA parameters as a function of the depth and the depth plus the depth increment.

In one embodiment, the classical computer program determines that a relative performance improvement for the basis coefficients is greater than the threshold; and the classical computer program interpolates a curve of the QAOA parameters as a function of the depth and the depth plus the depth increment.

In one embodiment, the classical computer program may also set a desired threshold for an approximation ratio.

According to another embodiment, a non-transitory computer readable storage medium may include instructions stored thereon, which when read and executed by one or more computer processors, cause the one or more computer processors to perform steps comprising: receiving a combinatorial optimization problem; initializing Quantum Approximate Optimization Algorithm (“QAOA”) parameters for a quantum circuit for the combinatorial optimization problem; setting an initial depth for the quantum circuit, a maximum depth for the quantum circuit, a choice of basis, and a number of basis coefficients; determining that a current depth of the quantum circuit is less than or equal to the maximum depth; transforming the QAOA parameters to the basis coefficients, wherein a number of basis coefficients is less than a number of QAOA parameter; determining that a relative performance improvement for the basis coefficients is less than a threshold; transforming the basis coefficients to the QAOA parameters; simulating execution of a quantum circuit with the QAOA parameters, resulting in a bitstring; updating the basis coefficients based on the bitstring; determining that a current depth of the quantum circuit is greater than the maximum depth; executing the quantum circuit with the optimized QAOA parameters based on the updated basis coefficients on a quantum computer, resulting in a final bitstring; and outputting the final bitstring as a solution to the combinatorial optimization problem.

In one embodiment, the basis may include a plurality of polynomials where any function on [0,1] interval can be represented as a linear combination of these polynomials.

In one embodiment, the basis may include a Chebyshev basis polynomial.

In one embodiment, the non-transitory computer readable storage medium may also instructions stored thereon, which when read and executed by the one or more computer processors, cause the one or more computer processors to perform steps comprising: setting a depth increment; increasing a number of coefficients by the depth increment in response the relative performance improvement being less than the threshold; and interpolating a curve of the QAOA parameters as a function of the depth and the depth plus the depth increment.

In one embodiment, the non-transitory computer readable storage medium may also instructions stored thereon, which when read and executed by the one or more computer processors, cause the one or more computer processors to perform steps comprising: determining that a relative performance improvement for the basis coefficients is greater than the threshold; and interpolating a curve of the QAOA parameters as a function of the depth and the depth plus the depth increment.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for parameter setting in quantum approximate optimization algorithm at high depth according to an embodiment;

FIG. 2 illustrates a method for parameter setting in quantum approximate optimization algorithm at high depth according to an embodiment;

FIG. 3 depicts an exemplary computing system for implementing aspects of the present disclosure.

### DETAILED DESCRIPTION OF PREFERRED EMBODIMENTS

Embodiments relate to systems and methods for parameter setting in quantum approximate optimization algorithm at high depth. The QAOA parameters include parameters within the phase operator (gamma or γ) and the mixing operator (beta or β) for each layer, p. In order to simplify the optimization of these QAOA parameters, in embodiments, the QAOA parameters may be transformed using the following equations:

$${γ}^{( p )} ( t ) = {\sum }_{k = 0}^{𝒞} {c}_{k}^{( γ )} {P}_{k} ( t )$$

$$and$$

$${β}^{( p )} ( t ) = {\sum }_{k = 0}^{𝒞} {c}_{k}^{( β )} {P}_{k} ( t )$$

where Pₖ is the polynomial associated with the new basis chosen and cₖ indicate the basis coefficients of that basis polynomial. Thus, embodiments use fewer basis coefficients for a successful representation of QAOA parameters.

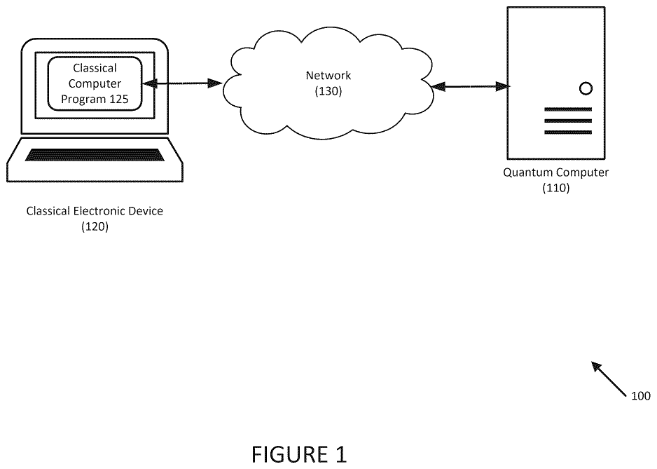

Referring to FIG. 1, a system for parameter setting in quantum approximate optimization algorithm at high depth is disclosed according to an embodiment. System 100 may include quantum computer 110 that may execute a quantum circuit, such as a QAOA circuit. A quantum circuit is a model for quantum computation that may include a sequence of quantum gates, measurements, initializations of qubits to known values, etc.

Quantum computer 110 may be a device that performs quantum computations, such as those based on the collective properties of quantum states including superposition, interference, and entanglement.

System 100 may also include classical electronic device 120 that may be any suitable general purpose computing device, including servers, workstations, desktops, notebooks, laptops, tablet computers, smart devices (e.g., smart phones, smart watches, etc.), Internet of Things (IoT) appliances, etc. For example, classical electronic device 120 may be a microprocessor-based device. Classical electronic device 120 may interface with quantum computer 110 using classical computer program 125, which may provide input to, and receive output from, quantum computer 110. In one embodiment, classical computer program 125 may generate a plurality of quantum circuits (i.e., models for quantum computing comprising a sequence of quantum gates, measurements, initializations of qubits to known values, and other actions), may transpile the quantum circuit(s) to machine-readable instructions, and may then send the transpiled circuit(s) over network 130 to quantum computer 110 for execution. Classical computer program 125 may also receive the results of the execution of the quantum circuits from quantum computer 110 also over network 130.

Classical computer program 125 may then adjust the QAOA parameters (i.e., gamma and beta) for the QAOA, and may repeat the process until the desired QAOA parameters are reached.

In one embodiment, network 130 may be a public network such as the Internet.

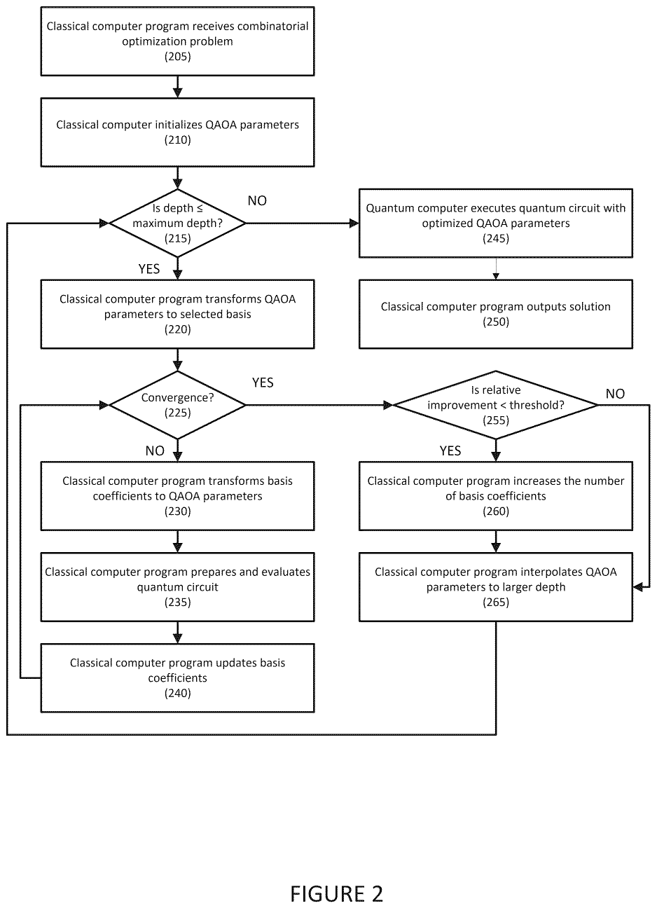

Referring to FIG. 2, a method for parameter setting in quantum approximate optimization algorithm at high depth is disclosed according to an embodiment.

In step 205, a classical computer program executed by a classical electronic device may receive a combinatorial optimization problem. A combinatorial optimization problem is a problem that seeks a value for a combination of variables that optimizes an index (value) from among many options under various constraints.

In step 210, the classical computer program may initialize QAOA parameters (i.e., gamma and beta) for a quantum circuit for the combinatorial optimization problem in QAOA. In one embodiment, an initial depth (e.g., an initial number of basis coefficients), a depth increment (e.g., an increment for increasing the number of basis coefficients), and others may also be initiated. For example, the classical computer program may set the initial depth (p) of the quantum circuit, may set the size of the depth increment (Δp) for interpolation, may set the maximum depth for the quantum circuit at which a desired approximation ratio (the difference between the current value of the objective function and the optimal value of the objective function, divided by the difference between the minimum and maximum values of the objective function) may be obtained, may set a desired threshold for the approximation ratio, a choice of basis, and a number basis coefficients of the basis polynomial (Pₖ) to be tuned.

The basis may be a collection of polynomials such that any function on [0,1] interval can be represented as a linear combination of these polynomials. For example, a few Chebyshev basis polynomials are given as:

$${P}_{0} ( t ) = 1 ; {P}_{1} ( T ) = 2 t ; {P}_{2} ( t ) = 4 {t}^{2} - 1 ; …$$

For example, for a fixed depth p, the 2p QAOA parameters are transformed to a different basis and optimized. Thus, to perform this transformation, the basis is selected, and the optimization involves tuning these basis coefficients corresponding to the chosen basis.

In step 215, the classical computer program may see if the current depth of the quantum circuit is less than or equal to the maximum depth. For the first iteration, the classical computer program may compare the initial depth to the maximum depth.

Alternately, the classical computer program may compare the approximation ratio to an approximation ratio threshold, which may be received as an input. If the approximation ratio is greater than or equal to the approximation ratio threshold, the process may continue to step 245. If it is not, the process may continue to step 220.

If the current depth is less than or equal to the maximum depth, in step 220, the classical computer program may transform the QAOA parameters to the basis. For example, the transformation may be represented as:

$${γ}^{( p )} ( t ) = {\sum }_{k = 0}^{𝒞} {c}_{k}^{( γ )} {P}_{k} ( t )$$

$$and$$

$${β}^{( p )} ( t ) = {\sum }_{k = 0}^{𝒞} {c}_{k}^{( β )} {P}_{k} ( t )$$

wherein t represents the fraction of schedule completed and takes values i/p with i∈{1, 2, . . . , p}. The basis coefficients

$${c}_{k}^{( γ )} and {c}_{k}^{( β )}$$

may be obtained by solving a system of linear equations. The number of basis coefficients is significantly lower in number compared to the 2p QAOA parameters, and instead of directly optimizing the gammas and betas, the basis coefficients are optimized.

In one embodiment, the coefficients may be determined by transforming the initial QAOA parameters using least squares or another regression method. This involves solving the following linear system:

$$A \vec{x} = \vec{b}$$

where A is a matrix constructed from the basis functions, \vec{x} is the vector of coefficients, and \vec{b} is the vector of target values for the QAOA parameters.

In step 225, after the initial step, the classical computer program may check if the optimization of the basis coefficients is successful (e.g., if convergence is reached). Such an optimization may fail due to numerical issues or something else, thus, there is this additional convergence check.

If there is convergence, in step 255, the classical computer program may compute the relative performance improvement, δ_{perf} that evaluates how much the performance has improved compared to the previous iteration, and may compare it to a threshold, which may be received as an input. The performance improvement may be, for example, the difference between the approximation ratio before and after the optimization.

If the relative performance improvement δ_{perf} is less than the threshold, in step 260, the classical computer program may increase the number of basis coefficients to be tuned. The increment (Δp) in the number of basis coefficients may be set by the user; by default, the increment may be set to 1. This allows for flexibility in the optimization process.

In step 265, the classical computer program may optionally perform interpolation of the curve of the QAOA parameters as a function of p to p+Δp. This increases the depth by the increment value (Δp) and, considering all of the previous steps were performed for a fixed p, the steps may be repeated for p+Δp. The process may return to step 215.

$${c}_{k}^{( γ )} and {c}_{k}^{( β )}$$

The basis coefficients may remain unchanged during this process, and the functional series may be evaluated at a higher number of points.

Thus, t now takes the values i/(p+Δp) with i∈{1, 2, . . . , p+Δp} with

$${γ}^{( p + Δp )} ( t ) = {\sum }_{k = 0}^{𝒞} {c}_{k}^{( γ )} {P}_{k} ( t )$$

$${β}^{( p + Δp )} ( t ) = {\sum }_{k = 0}^{𝒞} {c}_{k}^{( β )} {P}_{k} ( t )$$

Thus, the form of the QAOA parameters is preserved while increasing the resolution of the curve of the QAOA parameters.

If embodiments where the depth is not increased by the incremental value, the process may return to step 215.

If, in step 255, the relative performance improvement δ_{perf} is not less than the threshold, in the process may continue to step 265 without increasing the number of basis coefficients.

If, in step 225, there is no convergence, in step 230, the classical computer program may transform the basis coefficients to the QAOA parameters. For example, the basis coefficients,

$${c}_{k}^{( γ )} and {c}_{k}^{( β )} ,$$

are transformed to QAOA parameters the original basis in terms of the QAOA parameters using, for example, the equations in step 220, above.

In step 235, the classical computer program may prepare and evaluate a quantum circuit by, for example, simulating the execution of the quantum circuit. The classical computer program may then evaluate the quantum circuit. For example, the classical computer program may run the QAOA algorithm with the set of QAOA parameters obtained until this step and obtaining one or many bitstring(s) (e.g., a collection of bits), from which a metric of solution quality is checked.

The bitstrings in step 235 need not be optimal. Rather, it can be an intermediary bitstring, which helps in understanding how far the QAOA parameters are from the desired solution.

In step 240, based on the evaluation of the quantum computer program, the classical computer program may update the basis coefficients. For example, the basis coefficients may be tuned using a suitable numerical optimizer. For example, the bitstring(s) resulting from the simulation of the execution of the quantum circuit may be used to perform the optimization.

This may include adjusting the basis coefficients

$${c}_{k}^{( γ )} and {c}_{k}^{( β )}$$

to minimize the objective function from the constrained optimization problem for the new depth value.

The process may then return to step 225.

If, in step 215, the depth is not less than or equal to the maximum depth, in step 245, the classical computer program may execute the quantum circuit with the optimized QAOA parameters on a quantum computer, and in step 250 may read the solutions from measurement outcomes, such as a final bitstring, and output the solution. The final bitstring represents the solution to the combinatorial optimization problem.

In one embodiment, the final bitstring may be checked for quality using a metric of choice. For example, if there is an alternate solution to the given problem obtained though some other algorithm, then the final bitstring and that alternate solution's overlap can be checked to see if QAOA returned the correct result.

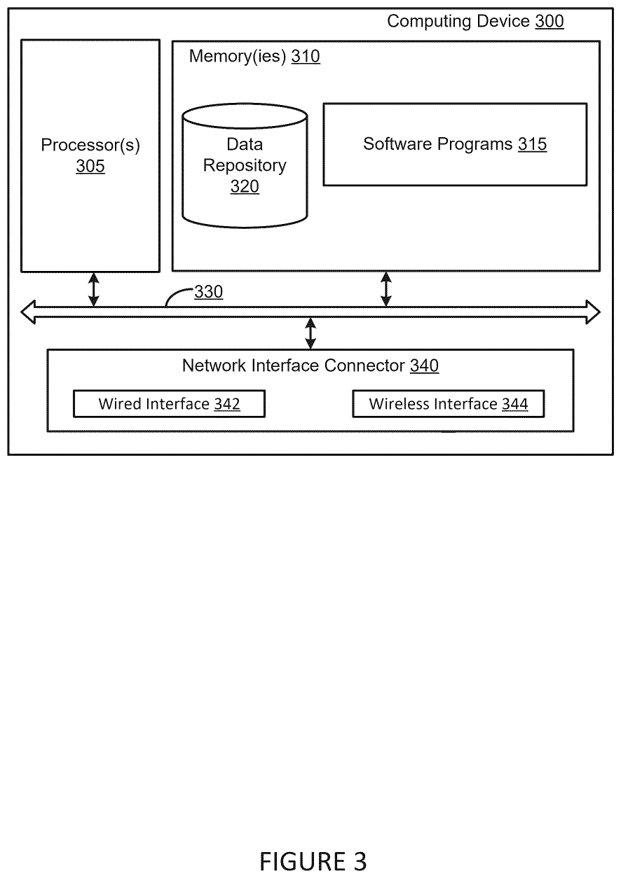

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a classical computer program executed by a classical electronic device, a combinatorial optimization problem;
initializing, by the classical computer program, Quantum Approximate Optimization Algorithm (“QAOA”) parameters for a quantum circuit for the combinatorial optimization problem;
setting, by the classical computer program, an initial depth for the quantum circuit, a maximum depth for the quantum circuit, a choice of basis, and a number of basis coefficients;
determining, by the classical computer program, that a current depth of the quantum circuit is less than or equal to the maximum depth;
transforming, by the classical computer program, the QAOA parameters to the basis coefficients, wherein a number of basis coefficients is less than a number of QAOA parameter;
determining, by the classical computer program, that a relative performance improvement for the basis coefficients is less than a threshold;
transforming, by the classical computer program, the basis coefficients to the QAOA parameters;
simulating, by the classical computer program, execution of a quantum circuit with the QAOA parameters, resulting in a bitstring;
updating, by the classical computer program, the basis coefficients based on the bitstring;
determining, by the classical computer program, that a current depth of the quantum circuit is greater than the maximum depth;
executing, by the classical computer, the quantum circuit with the optimized QAOA parameters based on the updated basis coefficients on a quantum computer, resulting in a final bitstring; and
outputting, by the classical computer, the final bitstring as a solution to the combinatorial optimization problem.

2. The method of claim 1, wherein the basis comprises a plurality of polynomials where any function on [0,1] interval can be represented as a linear combination of these polynomials.

3. The method of claim 1, wherein the basis comprises a Chebyshev basis polynomial.

4. The method of claim 1, further comprising:
setting, by the classical computer program, a depth increment;
increasing, by the classical computer program, a number of coefficients by the depth increment in response the relative performance improvement being less than the threshold; and
interpolating, by the classical computer program, a curve of the QAOA parameters as a function of the depth and the depth plus the depth increment.

5. The method of claim 4, further comprising:
determining, by the classical computer program, that a relative performance improvement for the basis coefficients is greater than the threshold; and
interpolating, by the classical computer program, a curve of the QAOA parameters as a function of the depth and the depth plus the depth increment.

6. The method of claim 1, wherein the classical computer program further sets a desired threshold for an approximation ratio.

7. A system, comprising:
a classical electronic device executing a classical computer program; and
a quantum computer in communication with the classical computer;
wherein:
the classical computer program receives a combinatorial optimization problem;
the classical computer program initializes Quantum Approximate Optimization Algorithm (“QAOA”) parameters for a quantum circuit for the combinatorial optimization problem;
the classical computer program sets an initial depth for the quantum circuit, a maximum depth for the quantum circuit, a choice of basis, and a number of basis coefficients;
the classical computer program determines that a current depth of the quantum circuit is less than or equal to the maximum depth;
the classical computer program transforms the QAOA parameters to the basis coefficients, wherein a number of basis coefficients is less than a number of QAOA parameter;
the classical computer program determines that a relative performance improvement for the basis coefficients is less than a threshold;
the classical computer program transforms the basis coefficients to the QAOA parameters;
the classical computer program simulates execution of a quantum circuit with the QAOA parameters, resulting in a bitstring;
the classical computer program updates the basis coefficients based on the bitstring;
the classical computer program determines that a current depth of the quantum circuit is greater than the maximum depth;
the quantum computer executes the quantum circuit with the optimized QAOA parameters based on the updated basis coefficients, resulting in a final bitstring; and
the classical computer outputs the final bitstring as a solution to the combinatorial optimization problem.

8. The system of claim 7, wherein the basis comprises a plurality of polynomials where any function on [0,1] interval can be represented as a linear combination of these polynomials.

9. The system of claim 7, wherein the basis comprises a Chebyshev basis polynomial.

10. The system of claim 7, wherein:
the classical computer program sets a depth increment;
the classical computer program increases a number of coefficients by the depth increment in response the relative performance improvement being less than the threshold; and
the classical computer program interpolates a curve of the QAOA parameters as a function of the depth and the depth plus the depth increment.

11. The system of claim 10, wherein:
the classical computer program determines that a relative performance improvement for the basis coefficients is greater than the threshold; and
the classical computer program interpolates a curve of the QAOA parameters as a function of the depth and the depth plus the depth increment.

12. The system of claim 7, wherein the classical computer program further sets a desired threshold for an approximation ratio.

13. A non-transitory computer readable storage medium, including instructions stored thereon, which when read and executed by one or more computer processors, cause the one or more computer processors to perform steps comprising:
receiving a combinatorial optimization problem;
initializing Quantum Approximate Optimization Algorithm (“QAOA”) parameters for a quantum circuit for the combinatorial optimization problem;
setting an initial depth for the quantum circuit, a maximum depth for the quantum circuit, a choice of basis, and a number of basis coefficients;
determining that a current depth of the quantum circuit is less than or equal to the maximum depth;
transforming the QAOA parameters to the basis coefficients, wherein a number of basis coefficients is less than a number of QAOA parameter;
determining that a relative performance improvement for the basis coefficients is less than a threshold;
transforming the basis coefficients to the QAOA parameters;
simulating execution of a quantum circuit with the QAOA parameters, resulting in a bitstring;
updating the basis coefficients based on the bitstring;
determining that a current depth of the quantum circuit is greater than the maximum depth;
executing the quantum circuit with the optimized QAOA parameters based on the updated basis coefficients on a quantum computer, resulting in a final bitstring; and
outputting the final bitstring as a solution to the combinatorial optimization problem.

14. The non-transitory computer readable storage medium of claim 13, wherein the basis comprises a plurality of polynomials where any function on [0,1] interval can be represented as a linear combination of these polynomials.

15. The non-transitory computer readable storage medium of claim 13, wherein the basis comprises a Chebyshev basis polynomial.

16. The non-transitory computer readable storage medium of claim 13, further including instructions stored thereon, which when read and executed by the one or more computer processors, cause the one or more computer processors to perform steps comprising:
setting a depth increment;
increasing a number of coefficients by the depth increment in response the relative performance improvement being less than the threshold; and
interpolating a curve of the QAOA parameters as a function of the depth and the depth plus the depth increment.

17. The non-transitory computer readable storage medium of claim 16, further including instructions stored thereon, which when read and executed by the one or more computer processors, cause the one or more computer processors to perform steps comprising:
determining that a relative performance improvement for the basis coefficients is greater than the threshold; and
interpolating a curve of the QAOA parameters as a function of the depth and the depth plus the depth increment.
